(19) United States
(12) Patent Application Publication
(10) Pub. No.: US 2007/0055471 A1
(43) Pub. Date: Mar. 8, 2007

(54) Copy window setpoint control for domain expansion reading

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,750

(22) PCT Filed: Jan. 20, 2004
(86) PCT No.: PCT/IB04/50042

§ 371 Date: Nov. 4, 2005

(30) Foreign Application Priority Data
May 9, 2003 (EP) 03101296.6

(51) Int. Cl. G01L 25/00

(52) U.S. Cl. 702/115

(57) ABSTRACT

The present invention relates to a recording medium, calibration method and apparatus for reading the recording medium, wherein the size of a spatial copy window of domain copying process is controlled by varying at least one predetermined reading parameter in response to a control information derived from a readout pulse, and by applying a predetermined additional pattern of change to said predetermined additional pattern of change to said predetermined parameter. A characteristic value, e.g. phase amplitude, of a phase change imposed on a reproduced data pattern by said additional pattern of change is used as a reference setpoint for copy window control. The data pattern reproduced by said reading apparatus may be monitored in order to determine a predetermined optimum value of the at least one predetermined parameter and to detect the characteristic value of said imposed phase change when the optimum value of said reading parameter is applied. As an alternative, the characteristic may be stored on the recording medium. A setpoint signal is provided thereby which can be accurately measured. Moreover, if the setpoint value is stored as an intrinsic property on the recording medium, the number of calibration operations can be significantly reduced.

The present invention relates to a recording medium, calibration method and apparatus for reading the recording medium, such as a MAMMOS (Magnetic AMplifying Magneto-Optical System) disc, comprising a recording or storage layer and an expansion or readout layer, wherein a copy window is dynamically controlled by varying a predetermined reading parameter in response to a control information derived from a readout pulse.

In conventional magneto-optical storage systems, the minimum width of the recorded marks is determined by the diffraction limit, i.e. by the Numerical Aperture (NA) of the focusing lens and the laser wavelength. A reduction of the width is generally based on shorter wavelength lasers and higher NA focusing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of the laser.

In domain expansion techniques, like MAMMOS, a written mark with a size smaller than the diffraction limit is copied from a storage layer to a readout layer upon laser heating with the help of an external magnetic field. Due to the low coercivity of this readout layer, the copied mark will expand to fill the optical spot and can be detected with a saturated signal level which is independent of the mark size. Reversal of the external magnetic field causes the expanded domain to collapse. A space in the storage layer, on the other hand, will not be copied and no expansion occurs. Therefore, no signal will be detected in this case.

To read out the bits or domains in the storage layer, the thermal profile of the optical spot is used. When the temperature of the readout layer is above a predetermined threshold value, the magnetic domains are copied from the storage layer to the magneto-statically coupled readout layer. This is because the stray field H_{S} from the storage layer, which is proportional to the magnetization of this layer, increases as a function of temperature. The magnetization M_{S} increases as a function of temperature for the temperature region just above a compensation temperature T_{comp}. This characteristic results from the use of a rare earth-transition metal (RE-TM) alloy which generates two counteracting magnetizations M_{RE} (rare earth component) and M_{TM} (transition metal component) with opposite directions.

The application of an external magnetic field, causes the copied domain in the readout layer to expand so as to give a saturated detection signal independent of the size of the original domain. The copying process is very non-linear. When the temperature is above the threshold value, magnetic domains are coupled from the storage layer to the readout layer. For temperatures above the threshold temperature the following condition is satisfied:
H_{S}+Hₑₓₜ≧H_{c} (1)
where H_{S} is the stray field of the storage layer at the readout layer, Hₑₓₜ is the externally applied field, and H_{c} is the coercive field of the readout layer. The spatial region where this copying occurs is called the ‘copy window’. The size w of the copy window is very critical for accurate readout. If the condition (1) is not fulfilled (copy window size w=0), no copying will take place at all. On the other hand, an oversized copy window will cause an overlap with neighbouring bits (marks) and will lead to additional ‘interference peaks’. The size of the copy window depends on the exact shape of the temperature profile (i.e. the exact laser power, but also the ambient temperature), the strength of the externally applied magnetic field, and on material parameters that may show short (or long) range variations.

The laser power used in the readout process should be high enough to enable copying. On the other hand, a higher laser power also increases the overlap of the temperature-induced coercivity profile and the stray field profile of the bit pattern. The coercivity H_{c} decreases and the stray field increases with increasing temperature. When this overlap becomes too large, correct readout of a space is no longer possible due to false signals generated by neighbouring marks. The difference between this maximum and the minimum laser power determines the power margin, which decreases strongly with decreasing bit length. Experiments have shown that the current methods can detect bit lengths of 0.10 μm correctly, but at a small power margin of less than 1%. Thus the power margin remains quite narrow for highest densities so that optical power control during readout is essential.

In MAMMOS, the synchronization of the external field with the recorded data is crucial. Accurate clock recovery is possible by using data-dependent field switching. Furthermore, the range of allowed laser powers for correct readout at high densities is quite narrow. However, this sensitivity to readout laser power can also be exploited to achieve an accurate power control loop, i.e. a dynamic copy window control, using the readout signals from the recorded data. This is done by adding a small modulating component to the laser power, thus inducing timing shifts of the MAMMOS signals. Any change in laser power, external field, or ambient temperature can be corrected through, for example lock-in detection of these shifts, to keep the copy window constant. In this way, accurate and robust readout is possible, allowing much higher densities than with a conventional system.

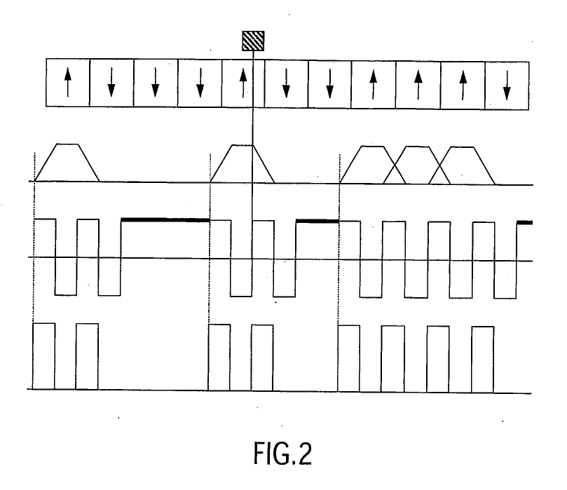

FIG. 2 shows some key signals for readout of MAMMOS discs in a steady-state situation with constant laser power, constant ambient temperature, homogeneous disc properties, constant field strength, constant coil-disc distance, etc. The top graph shows the magnetic bits in the storage layer. The second graph shows the overlap signal (convolution) of the magnetic bit pattern and the copy window. The third graph shows the external magnetic field, and the bottom graph shows the obtained MAMMOS signal. When the overlap signal is non-zero, copying of domains will take place. The external magnetic field is kept high until a bit or domain is copied from the storage layer and expanded in the readout layer (cf. bold lines in FIG. 2). Then, after a fixed delay, the external field is reversed and the domain is collapsed until the next bit transition or domain copying occurs.

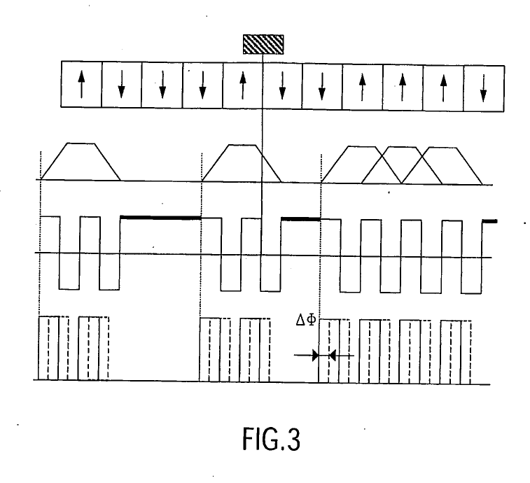

FIG. 3 shows a diagram similar to FIG. 2, but now one of the parameters to be controlled, e.g. the laser power, is increased deliberately, e.g. according to the above described dynamic copy window control feature. This increase/decrease (wobbling) is done with a predefined change pattern, e.g. a periodic pattern with a small amplitude. The wobbling causes the copy window to increase or decrease in size synchronously with the wobble frequency. Comparing FIGS. 2 and 3, it becomes clear that when the copy window increases in size the next transition will appear somewhat earlier than expected. On the other hand, when the copy window decreases in size the next transition will be delayed slightly. This is indicated by the phase error amplitude ΔΦ shown in FIG. 3.

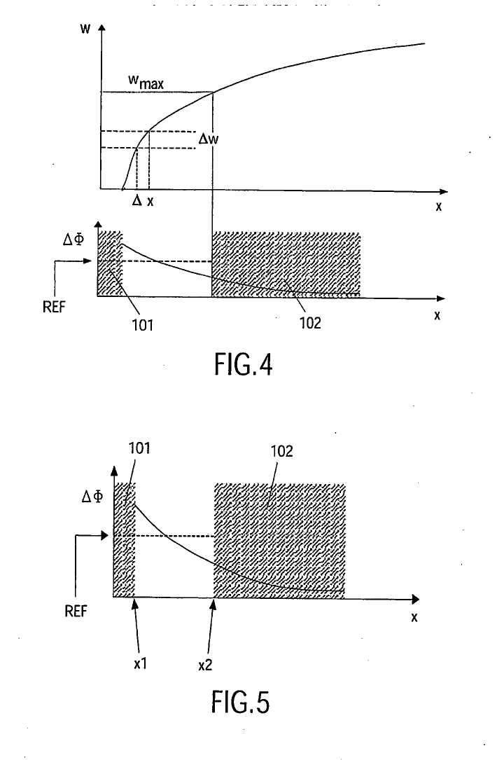

The top part of FIG. 4 schematically shows the dependence of the copy window size w on the reading or readout parameter x, i.e. the laser power and/or the external field. A modulation in the readout parameters with an amplitude Δx induces a corresponding variation Δw in copy window size, which directly gives rise to a phase variation with an amplitude ΔΦ as indicated in the bottom part of FIG. 4. This phase amplitude ΔΦ is a direct measure for the readout parameter due to the non-linear square-root-like dependency of the copy window size w on the readout parameter x. To obtain an absolute error signal to be used as input for the copy window control loop, the control method requires a suitable reference setpoint which corresponds to the optimum readout parameters, e.g. external field and/or laser power. However, no methods have been proposed so far to determine and calibrate this setpoint. A suitable setpoint may be found using a calibration procedure. However, this takes some time, thus increasing the start-up time.

It is an object of the present invention to provide a reading system and calibration method by means of which a suitable reference setpoint can be obtained and easily calibrated. This object is achieved by a method as claimed in claim 1, by an apparatus as claimed in claim 13, and by a record carrier as claimed in claim 20.

Accordingly, the use of the characteristic value of the phase change signal corresponding to the optimum readout parameters as a reference point means that this value does not depend on changes in the temperature and can be measured very easily and accurately by means of a lock-in detection of the output of the phase detector in the clock recovery phase locked loop. Thus, hardly any modifications to the hardware are required.

Furthermore, the alternative or additional measure of storing this setpoint on the recording medium avoids unnecessary calibrations. The setpoint can be pre-set in the factory and only needs to be updated in the recording apparatus in the case of readout problems, e.g. non-standard player, aging of disc or the like, by performing a calibration, e.g. as proposed above.

The at least one limit value may comprise a lower limit value determined by the occurrence of at least one missing peak in the reproduced data pattern, and an upper limit value determined by the occurrence of at least one false peak in the reproduced data pattern In particular, the predetermined value may be a value located between the lower and upper limit values, e.g. roughly in the middle between the lower and upper limit values.

Furthermore, the predetermined reading parameter may correspond to the value of at least one of the following quantities: radiation power and external magnetic field.

The additional change pattern may be a periodic modulation pattern having a predetermined frequency.

The monitored reproduced data pattern may be a predetermined and thus known data pattern provided in a calibration area of the recording medium. Thereby, the amount of data analysis can be kept to a minimum. As an alternative, the monitored reproduced data pattern may be an arbitrary user data pattern provided in a recording area of the recording medium, wherein the determination step may be based on a runlength violation detection.

The at least one predetermined reading parameter may be passively sweeped from a lower value to a higher value or vice versa during the variation step, the lower value being lower than all possible values of the lower limit value and the higher value being higher than all possible values of the upper limit value.

Alternatively, the at least one predetermined reading parameter may be actively changed from an initial default value to a lower value or to a higher value during the variation step, the direction of change being determined in response to the number of false peaks or missing peaks determined in the reproduced data pattern during the monitoring step.

In both cases, the lower limit value may be set to a value corresponding to the lower value if a number of missing peaks detected during the monitoring step has reached a first predetermined threshold value, and the upper limit value may be set to a value corresponding to said upper value if a number of false peaks detected during the monitoring step has reached a second predetermined threshold value.

The use of the information about the number of missing or false peaks may be based on a detection of the difference between detected and expected peaks, thus providing a quick and simple control feedback.

The calibration means of the reading apparatus may be adapted to monitor the data pattern reproduced by the reading apparatus in order to determine the predetermined optimum value of the at least one predetermined parameter, and to detect the characteristic value of the induced phase change when the optimum value of the reading parameter is applied.

As an alternative or additional measure, the reading apparatus may be arranged to read the characteristic value from the recording medium and to supply the characteristic value to the calibration means. In particular, the reading apparatus may be arranged to read the characteristic value from the recording medium based on at least one predetermined parameter of the recording medium. The at least one predetermined parameter of the recording medium may comprise at least one of the following: a radial position and a reading velocity. Of course, the stored characteristic value may be read in dependence on other parameters of the recording medium which might influence the characteristic value. Hence, the characteristic value can be treated as an intrinsic property of the recording medium and can be pre-set during manufacture thereof.

The calibration information stored on the recording medium may define a plurality of reference setpoints for different values of at least one parameter of the record carrier.

Other advantageous further developments are defined in the dependent claims.

In the following, the present invention will be described on the basis of preferred embodiments with reference to the accompanying drawings, in which:

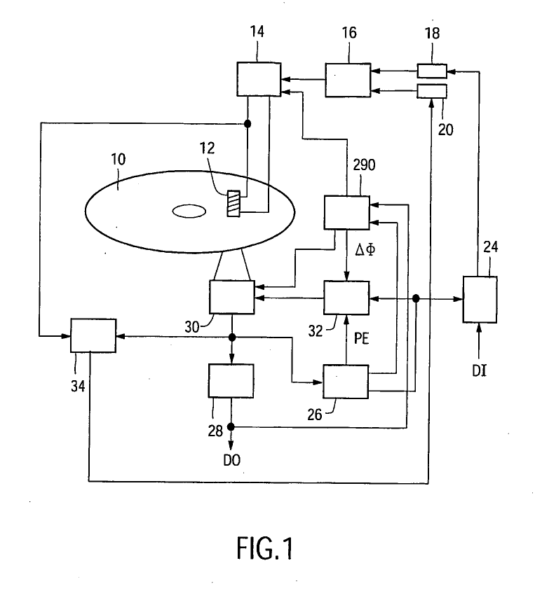

FIG. 1 shows a schematic diagram of a magneto-optical disc player, according to the preferred embodiments;

FIG. 2 shows a diagram indicating characteristic signals of a MAMMOS readout scheme for a predetermined constant copy window size;

FIG. 3 shows a diagram indicating characteristic signals of a MAMMOS readout scheme for an increased copy window size leading to a timing shift of the detected MAMMOS peaks;

FIG. 4 shows diagrams indicating dependencies between a predetermined reading parameter, a copy window size, and a phase change;

FIG. 5 shows diagrams indicating an allowable variation range for the reading parameter;

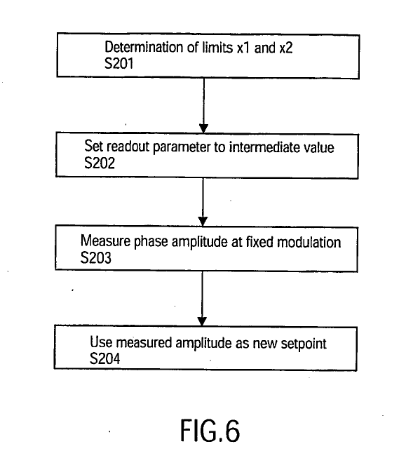

FIG. 6 shows a flow diagram of a calibration method according to a first preferred embodiment; and

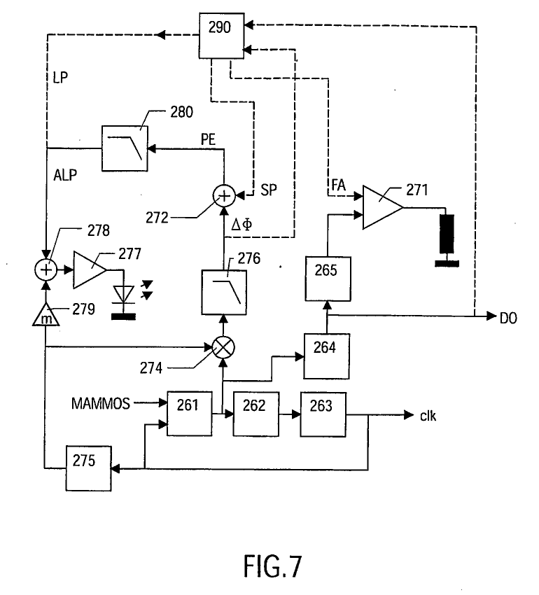

FIG. 7 shows a schematic block diagram of a copy window control circuitry with a calibration functionality according to the first and a second preferred embodiment.

The preferred embodiments will now be described on the basis of a MAMMOS disc player as indicated in FIG. 1. FIG. 1 schematically shows the construction of the disc player according to the preferred embodiments. The disc player comprises an optical pick-up unit 30 having a laser light radiating section for irradiation of a magneto-optical recording medium or record carrier 10, such as a magneto-optical disc, with light that has been converted, during recording, into pulses with a pulse cycle synchronized with code data, and a magnetic field applying section comprising a magnetic head 12 which applies a magnetic field in a controlled manner during recording and playback on the magneto-optical disc 10. In the optical pick-up unit 30, a laser is connected to a laser driving circuit which receives recording and readout pulses from a recording/readout pulse adjusting unit 32 so as to control the pulse amplitude and timing of the laser of the optical pick-up unit 30 during a recording and readout operation. The recording/readout pulse adjusting circuit 32 receives a clock signal from a clock generator 26 which comprises a PLL (Phase Locked Loop) circuit.

It is noted that, for reasons of simplicity, the magnetic head 12 and the optical pickup unit 30 are shown on opposite sides of the disc 10 in FIG. 1. However, according to the preferred embodiment, they should be arranged on the same side of the disc 10.

The magnetic head 12 is connected to a head driver unit 14 and receives, at the time of recording, code-converted data via a phase adjusting circuit 18 from a modulator 24. The modulator 24 converts input recording data DI into a prescribed code.

During playback the head driver 14 receives a timing signal via a playback adjusting circuit 20 from a timing circuit 34, said playback adjusting circuit 20 generating a synchronization signal for adjusting the timing and amplitude of pulses applied to the magnetic head 12. The timing circuit 34 derives its timing signal from the data readout operation. Thus, a data dependent field switching can be achieved. A recording/playback switch 16 is provided for switching or selecting the respective signal to be supplied to the head driver 14 during recording and during playback.

Furthermore, the optical pick-up unit 30 comprises a detector for detecting laser light reflected from the disc 10 and for generating a corresponding reading signal applied to a decoder 28 which is arranged to decode the reading signal so as to generate output data DO. Furthermore, the reading signal generated by the optical pick-up unit 30 is supplied to a clock generator 26 in which a clock signal obtained from embossed clock marks of the disc 10 is extracted or recovered, and which supplies the clock signal for synchronization purposes to the recording pulse adjusting circuit 32 and to the modulator 24. In particular, a data channel clock may be generated in the PLL circuit of the clock generator 26. It is noted that the clock signal obtained from the clock generator 26 may alternatively be supplied to the playback adjusting circuit 20 so as to provide a reference or fallback synchronization which may support the data-dependent switching or synchronization controlled by the timing circuit 34.

In case of data recording, the laser of the optical pick-up unit 30 is modulated with a fixed frequency corresponding to the cycle of the data channel clock, and the data recording area or spot of the rotating disc 10 is locally heated at equal distances. Additionally, the data channel clock provided by the clock generator 26 controls the modulator 24 to generate a data signal with the standard clock period. The recording data are modulated and code-converted by the modulator 24 to obtain a binary run length information corresponding to the information of the recording data.

The structure of the magneto-optical recording medium 10 may correspond to the structure described in the JP-A-2000-260079.

In FIG. 1, the timing circuit 34 is provided for supplying a data-dependent timing signal to the playback adjusting circuit 20. As an alternative, the data-dependent switching of the external magnetic field may be achieved by supplying the timing signal to the head driver 14, so as to adjust the timing or phase of the external magnetic field. The timing information is obtained from the (user) data on the disc 10. To achieve this, the playback adjusting circuit 20 or the head driver 14 are adapted to provide an external magnetic field which is normally in the expansion direction. When a rising signal edge of a MAMMOS peak is observed by the timing circuit 34 at an input line connected to the output of the optical pickup unit 30, the timing signal is supplied to the playback adjusting circuit 20 such that the head driver 14 is controlled to reverse the magnetic field after a short time for collapsing the expanded domain in the readout layer, and shortly after that to reset the magnetic field to the expansion direction. The total time between the peak detection and the field reset is set by the timing circuit 34 to correspond to the sum of the maximum allowed copy window and one channel bit length on the disc 10 (times the linear disc velocity).

Furthermore, a dynamic copy window control function is provided by applying a modulation, e.g. wobble or change pattern, to the laser power control signal and continuously measuring the size w of the copy window using information from the detected data signal in the read mode. When the wobble frequency lies above the bandwidth of the clock recovery PLL circuit of the clock generator 26, the phase error of this PLL circuit can be used to detect the small deviation or phase error with respect to the expected transition position.

The frequency deviation of the introduced wobble or change pattern should have a zero average value. However, the amplitude ΔΦ of the phase error obtained here cannot be used yet as an absolute error signal for laser power control as only the absolute scale is known, but no reference (zero or offset) is present. I.e., only changes in the size of the copy window can be measured. To circumvent this problem, the derivative of the copy window size w as a function of temperature can be measured to obtain a control information for controlling the size w of the copy window. Due to the fact that the derivative or amount of change of the copy window size w directly leads to the phase amplitude ΔΦ, the amplitude ΔΦ of the detected phase error corresponds to the derivative and can thus be used for copy window control. As a reference condition, this amplitude ΔΦ of the phase error must fulfill an initially determined set condition or setpoint. The deviation from this setpoint then can be used as a control signal PE for the laser power control procedure or for controlling any other suitable reading parameter, e.g. the strength of the external magnetic field.

Any changes in the size of the copy window due to changes in parameters, such as coil-disc distance, ambient temperature, etc., are compensated for the controlled parameter, e.g. laser power in the present example.

However, since the w vs x curve shown in FIG. 4 will shift horizontally in dependence on the ambient temperature, e.g. if the temperature in the drive changes during operation, it is not sufficient to store ‘optimum’ values for the laser power and the external field. These ‘optimum’ values will be different at a different temperatures. Moreover, absolute measurements of these values are far from trivial in a drive. The detectors and probes used for this purpose are prone to drift and need calibration as well. According to the preferred embodiments, it is thus proposed to use the phase amplitude corresponding to the optimum readout parameters as a reference point. This value does not depend on changes in the temperature and can be measured very easily and accurately by means of a lock-in detection of the output of the phase detector in the clock recovery PLL circuit of the clock generator 26.

FIG. 5 shows a diagram similar to the lower part of FIG. 4, wherein the range of readout parameters for correct readout is indicated between x1 and x2, where x1 is defined as the lower limit of the correct readout parameter and x2 as the upper limit. For example, within a lower forbidden area 101, the laser power is lower than x1 and mark run lengths will yield fewer MAMMOS peaks than expected. Similarly, within an upper forbidden area 102, the laser power is higher than x2 and will yield additional false peaks.

FIG. 6 shows a flow diagram of a calibration method according to the first preferred embodiment. In the proposed calibration method, the limits x1 and x2 are first determined in step S201 by varying the readout parameters while monitoring and analyzing the reproduced data patterns. No modulation Δx is used and the window control loop is not closed, i.e. the copy window control is not active. Then, in step S202, the readout parameter is set to a value between x1 and x2, preferably around (x1+x2)/2. In the following step S203, a fixed modulation Δx is applied, as in a case in which the control loop is active, and the corresponding phase amplitude ΔΦ is measured. This measured phase amplitude ΔΦ is then used as the new setpoint value SP, which can be used to (re-)activate the copy window control loop.

In the disc player shown in FIG. 1, a corresponding calibration circuit 290 is provided which is adapted to determine the setpoint value SP for the clock generator 26. According to the first preferred embodiment, this setpoint value is determined by using the calibration procedure of FIG. 6. As an alternative or in addition thereto, according to the second preferred embodiment, the setpoint value SP may be pre-stored on the disc to be read and supplied to the calibration circuit 290.

FIG. 7 shows a more detailed functional block diagram of the copy window control functionality with the control signals of the calibration circuit 290. Blocks 261 to 265 constitute the PLL part, and blocks 274 and 276 constitute a lock-in detection function, i.e. multiplication of the signal by a modulation frequency causes sum and difference frequencies, followed by low-pass filtering giving a DC value, i.e. equivalent of lock-in. The corresponding calibration control signals of the first preferred embodiment are indicated by dashed lines.

Similar block diagrams can be made for a copy window control method based on modulation of the external field or a combination of laser and field. The control signal PE may then be additionally or solely supplied to the head drive unit 14.

In FIG. 7, the detected MAMMOS run length signal obtained from the pickup unit 30 of FIG. 1 is supplied to a phase detector 261 of the PLL circuit of the clock generator 26 of FIG. 1, in which the phase of the run length signal is compared with the phase of an output signal of a voltage-controlled oscillator (VCO) 263 of the PLL circuit. Additionally, the feedback signal is supplied to a clock divider 275 which divides the clock frequency and supplies it to a modulation circuit 279 for laser power modulation. The output of the phase detector 261, which corresponds to the phase difference between the run length signal and the feedback signal, is supplied to a loop filter 262 for extracting the desired frequency to be phase-controlled in the PLL circuit.

Due to the data dependent field switching, the high-frequency components of the phase error from the phase detector 261 contain the pulse positions of the reproduced data. When the laser power is modulated at a frequency M times lower than the bit clock, the phase error from the phase detector 261 will contain synchronous, low-frequency laser power error information which is demodulated by a demodulation or mixing circuit 274, to which the laser modulation signal at the output of the clock divider 275 is supplied, and extracted using a low-pass filter 276. The combination of the mixing circuit and the low-pass filter is the equivalent of a bandpass filter around the modulation frequency, i.e. ‘lock-in’ detection. The extracted phase error signal is then supplied to an adding circuit 272 in which the setpoint value SP is added, and the obtained sum value is used as the control signal PE for power control which is supplied to an averaging circuit 280, e.g. a filter or integrator circuit, to obtain an averaged power control signal ALP to be added to the laser power modulating signal in an additional adding circuit 278. The combined power control signal is supplied via a driving amplifier 277 to the laser diode of the pickup unit 30 of FIG. 1.

The recovered output clock is also supplied to a bit detector 264 that detects the presence of a bit in the output signal of the phase detector 261. The detected bit information is outputted as the output data DO. This output data DO together with the recovered output clock is supplied to a field switching control unit 265 which controls a coil driver 271 of the field coil of the magnetic head 12 for generating the magnetic field. In this way the data dependent field switching function is implemented.

The laser modulation also causes the pulse positions to shift, depending on the sign of the modulation, as illustrated in FIG. 3. This means that the average pulse position in subsequent low periods and in subsequent high periods is no longer DC-free.

Different approaches are possible for the determination of x1 and x2 (step 201 in FIG. 6) by the calibration circuit 290. Calibration areas with a known data pattern provided on the disc 10 keep the data analysis to a minimum, since any deviation in the detected number of peaks, i.e. too few below x1, too many above x2, is immediately clear. Calibration on user data is also possible in principle, but robust run length violation detection requires special precautions and/or longer data sequences, leading to a slower calibration procedure. Therefore, fixed calibration patterns seem preferable.

The variation in readout parameter at the calibration circuit 290, e.g. laser power LP and/or field amplitude FA as indicated by the dotted arrows in FIG. 7, may be either passive or active. In the passive case, the parameter is swept from a lower to a higher value, or vice versa, while the reproduced data is being analyzed. This sweep may be continuous or in steps corresponding to the required accuracy. The lower value should always be lower than x1 and the higher value should always be higher than x2, i.e. for all allowed temperatures and disc properties, for example. During the sweep, the current readout parameter value is stored in x1 as soon as the transition from ‘too few peaks’ to ‘OK’ is detected, or vice versa for the high-to-low sweep, and it is stored in x2 as soon as the transition from ‘OK’ to ‘too many peaks’ is detected, or vice versa for the high-to-low sweep.

An example of an active approach, where the change in readout parameter depends on the detected data, is to start e.g. from a preset value which may have been determined and set for the readout parameter during the manufacture of the disc 10. Depending on the reproduced data, i.e. too few, OK, or too many peaks, the parameter is either increased or decreased, continuously or in steps, until a transition is detected, and either x1 or x2 is stored. Then this procedure is repeated to find the second transition. For example, after detection of x1 upon an increase of x, wherein the starting point was below x1, x is further increased up to x2. Similarly, after x2 upon a decrease of x, wherein the starting point was above x2, x is further decreased down to x1.

The proposed calibration procedure thus provides an accurate determination of the setpoint signal using the existing hardware and a method of calibrating it to the optimum readout parameters.

Since the difference in the number of detected and expected peaks is a (non-linear) measure of the deviation from the optimum readout parameter, this information may be used to quickly provide a coarse correction of the readout parameter value.

For RF-MAMMOS, in which the external field is changed at a high frequency, copy window control is essential, for high densities at practical margins. As was proposed above, the phase amplitude induced by the readout parameter modulation is a suitable setpoint, which can be found by the simple calibration procedure described in connection with the first preferred embodiment. However, this calibration procedure takes some time and thus leads to an increased start-up time. Moreover, such a setpoint is usually found to vary as a function of the disc's radius due to a non-uniformity in disc composition, different linear velocities or the like, which result in different thermal profiles, so that regular re-calibration may be required during playback.

According to FIG. 4, the relation between a fixed, applied modulation in the readout parameters with an amplitude Δx and the resulting copy window change ΔΦ and corresponding phase amplitude ΔΦ is completely determined by the dependency of the copy window size w on the readout parameter x. The shape of the curve shown in the upper part of FIG. 4 is defined by the thermal profile induced in the disc 10 and by its magnetic properties, mainly the readout layer's coercivity versus temperature. Other effects like ambient temperature or external field strength result in a horizontal shift but the shape stays constant Hence, such a shift will change the value of the optimum readout parameters, but the phase amplitude setpoint value SP will always correspond to the optimum in readout parameters.

The thermal profile is fixed by the optics, i.e. laser wavelength and numerical aperture of the objective lens, and the prescribed linear disc velocity, which are standardized and therefore accurately specified, and by the disc's layer stack. This means that the phase amplitude setpoint value SP can be treated as an intrinsic property of the disc.

Hence, in the second preferred embodiment, it is proposed to store/update this setpoint or possibly separate setpoints on the disc 10 for at least one of different radii, different velocities, and other suitable disc parameters which influence the setpoint, so that calibration only needs to be performed in case of unexpected problems. Unnecessary calibrations are therefore avoided. The setpoint value SP can then be pre-set in the factory during manufacture of the disc 10 and only needs to be updated in the disc player in case of readout problems (e.g. non-standard player, aging of disc) by performing a calibration e.g. as described in the first preferred embodiment.

Since the magnetic properties are highly dependent on the layer composition and strict radial uniformity is difficult to achieve, it is beneficial to store separate setpoint values for different radial positions or ranges thereof Such an approach is also useful to define separate setpoint values for different linear velocities or velocity ranges, e.g. in case of a constant angular velocity (CAV) or zoned CAV operation.

According to the second preferred embodiment, the calibration circuit 290 is arranged to obtain the default or preset setpoint value(s) from the disc 10 based on an initial readout operation. In case of several setpoint values, the calibration circuit 290 may be arranged to select the current setpoint value SP in dependence on the prevailing disc property, e.g. radial position or angular velocity.

It is noted that the present invention may be applied to any reading system for domain expansion magneto-optical disc storage systems in which a copy window control function is used. Any suitable reading parameter may be varied during the calibration procedure to obtain the optimum setpoint value SP. Furthermore, any suitable change pattern may be applied to the selected reading parameter so as to derive the upper and lower limit values x1 and x2, or more values or even only a single limit value, on the basis of which the optimum setpoint value SP can be obtained. The calibration circuit 270 may be implemented by a hardware circuit or a software controlled analog or digital processing circuit, or may be incorporated as a new routine of an existing control program for controlling the disc player. The preferred embodiments may thus vary within the scope of the attached claims.

1. A calibration method for calibration of a copy window control setpoint during readout of a magneto-optical recording medium (10) comprising a storage layer and a readout layer, wherein an expanded domain leading to a readout pulse is generated in said readout layer by copying a mark region from said storage layer to said readout layer upon heating by a radiation power with the help of said external magnetic field, said method comprising the steps of:
a) varying at least one predetermined reading parameter;
b) monitoring a data pattern reproduced during said variation step;
c) determining at least one limit value for said at least one predetermined reading parameter based on said monitored data pattern;
d) setting said at least one reading parameter to a predetermined value determined on the basis of said limit value;
e) applying a predetermined additional pattern of change to said predetermined parameter; and
f) using a characteristic value of a phase change induced to said reproduced data pattern by said additional pattern of change as said control setpoint.

2. A method according to claim 1, wherein said at least one limit value comprises a lower limit value (x1) determined by the occurrence of at least one missing peak in said reproduced data pattern and an upper limit value (x2) determined by the occurrence of at least one false peak in said reproduced data pattern.

3. A method according to claim 1, wherein said characteristic value corresponds to the amplitude of said phase change.

4. A method according to claim 2, wherein said predetermined value is a value located between said lower and upper limit values.

5. A method according to claim 2, wherein said predetermined value is value roughly located in the middle between said lower and upper limit values.

6. A method according to claim 1, wherein said predetermined reading parameter corresponds to at least one of the following values: the value of said radiation power and the value of said external magnetic field.

7. A method according to claim 1, wherein said additional change pattern is a periodic modulation pattern having a predetermined frequency.

8. A method according to claim 1, wherein said reproduced data pattern is a predetermined data pattern provided in a calibration area of said recording medium (10).

9. A method according to claim 1, wherein said reproduced data pattern is an arbitrary user data pattern provided in a recording area of said recording medium (10), and wherein said determination step is based on a runlength violation detection.

10. A method according to claim 1, wherein said at least one predetermined reading parameter is passively swept from a lower value to a higher value or vice versa during said variation step, said lower value being lower than all possible values of said lower limit value (x1) and said higher value being higher than all possible values of said upper limit value (x2).

11. A method according to claim 1, wherein said at least one predetermined reading parameter is actively changed from an initial default value to a lower value or to a higher value during said variation step, the direction of change being determined in response to the number of false peaks or missing peaks determined in said reproduced data pattern during said monitoring step.

12. A method according to claim 10, wherein said lower limit value (x1) is set to a value corresponding to said lower value if a number of missing peaks detected during said monitoring step has reached a first predetermined threshold value, and said upper limit value (x2) is set to a value corresponding to said upper value if a number of false peaks detected during said monitoring step has reached a second predetermined threshold value.

13. A reading apparatus for reading from a magneto-optical recording medium (10) comprising a storage layer and a readout layer, wherein an expanded domain leading to a readout pulse is generated in said readout layer by copying a mark region from said storage layer to said readout layer upon heating by a radiation power with the help of an external magnetic field, said apparatus comprising:
a) control means (30, 32) for controlling the size of a spatial copy window of said copying process by varying at least one predetermined reading parameter in response to a control information derived from said readout pulse;
b) change means (32) for applying a predetermined additional pattern of change to said at least one predetermined parameter; and
c) calibration means (290) for using a characteristic value of a phase change induced to a reproduced data pattern by said additional pattern of change as a reference setpoint for said control means (30, 32).

14. A reading apparatus according to claim 13, wherein said calibration means (290) is adapted to monitor said data pattern reproduced by said reading apparatus in order to determine a predetermined optimum value of said at least one predetermined parameter, and to detect said characteristic value of said induced phase change when said optimum value of said reading parameter is applied.

15. A reading apparatus according to claim 13, wherein said reading apparatus is arranged to read said characteristic value from said recording medium (10) and to supply said characteristic value to said calibration means (290).

16. A reading apparatus according to claim 15, wherein said reading apparatus is arranged to read said characteristic value from said recording medium (10) based on at least one predetermined parameter of said recording medium (10).

17. A reading apparatus according to claim 16, wherein said at least one predetermined parameter of said recording medium (10) comprises at least one of the following: a radial position and a reading velocity.

18. A reading apparatus according to claim 13, wherein said characteristic value corresponds to the amplitude of said phase change.

19. A reading apparatus according to claim 13, wherein said reading apparatus is a disc player for MAMMOS discs.

20. A recording medium comprising a storage layer and a readout layer, wherein an expanded domain leading to a readout pulse is generated in said readout layer by copying a mark region from said storage layer to said readout layer upon heating by a radiation power with the help of an external magnetic field, said recording medium (10) having written thereon a calibration information defining a reference setpoint for controlling the size of a spatial copy window of said copying process.

21. A recording medium according to claim 20, wherein said calibration information defines a plurality of reference setpoints for different values of at least one parameter of said recording medium (10).

22. A recording medium according to claim 21, wherein said at least one predetermined parameter of said recording medium (10) comprises at least one of the following: a radial position and a reading velocity.

23. A recording medium according to claim 20, wherein said characteristic value corresponds to a phase amplitude of a data pattern reproduced from said recording medium (10).

24. A recording medium according to claim 20, further comprising a calibration area with a predetermined data pattern for calibration of said reference setpoint.

25. A recording medium according to claim 20, further comprising a calibration area with an arbitrary user data pattern for calibration of said reference setpoint.

26. A recording medium according to claim 20, wherein said recording medium is a MAMMOS disc (10).
